(19) United States
(12) Patent Application Publication
(10) Pub. No.: US 2026/0211610 A1
(43) Pub. Date: Jul. 23, 2026

(54) METHOD FOR PERFORMING AUDIO OFFLOAD CONTROL IN MULTI-PIPELINE ARCHITECTURE, AND ASSOCIATED APPARATUS

(71) Applicant: Mediatek Inc., Hsinchu City (TW)

(72) Inventor: Jou Lee, Hsinchu City (TW)

(73) Assignee: MEDIATEK INC., Hsinchu City (TW)

(21) Appl. No.: 19/026,552

(22) Filed: Jan. 17, 2025

(51) Int. Cl. G06F 3/16

(52) U.S. Cl. CPC G06F 3/162

(57) ABSTRACT

A method for performing audio offload control in multi-pipeline architecture and associated apparatus such as electronic device are provided. The method may include utilizing a first audio-processing pipeline among multiple audio-processing pipelines to perform first audio processing, for example: utilizing the first audio-processing pipeline to receive first audio data of a first audio, wherein a first playback length of the first audio data is less than a first predetermined playback length; utilizing a bitstream buffer inserted between a first program module corresponding to a first layer and a second program module corresponding to a second layer within the first audio-processing pipeline to store the first audio data, for further processing with the second program module; and utilizing at least one subsequent program module within the first audio-processing pipeline, such as the second program module, to process the first audio data, for offloading among different portions of at least one processor.

### BACKGROUND

The present invention is related to audio control, and more particularly, to a method for performing audio offload control in multi-pipeline architecture, and an associated apparatus such as an electronic device.

Nowadays people may rely more and more on communication software in their daily lives. In addition to the use of music and video, the use of short audio sounds, such as notification sounds and ringtones, may have become integrated into daily usage scenarios. According to the related art, in the design of modern mobile devices, short audio sounds are typically not offloaded to a subsystem microprocessor, however. The modern mobile devices may have been designed without considering the possibility that these short audio sounds such as notification sounds, alarms and ringtones may be played for a long period of time, leading to increased power consumption. Thus, a novel method and associated architecture are needed for solving the problem without introducing any side effect or in a way that is less likely to introduce a side effect.

### SUMMARY

It is an objective of the present invention to provide a method for performing audio offload control in multi-pipeline architecture, and an associated apparatus such as an electronic device, in order to solve the above-mentioned problem, and more particularly, realize an offload architecture for power consumption optimization specifically for short audio sounds.

At least one embodiment of the present invention provides a method for performing audio offload control in multi-pipeline architecture, where the method is applicable to an electronic device. The method may comprise: utilizing a first audio-processing pipeline among multiple audio-processing pipelines to perform first audio processing, wherein each audio-processing pipeline among the multiple audio-processing pipelines comprises multiple audio-processing modules running on at least one processor within the electronic device, such as the multiple audio-processing modules respectively belonging to multiple layers of program modules running on the at least one processor. For example, the first audio processing may comprise: utilizing the first audio-processing pipeline to receive first audio data of a first audio, wherein a first playback length of the first audio data is less than a first predetermined playback length; utilizing a bitstream buffer inserted between a first program module corresponding to a first layer and a second program module corresponding to a second layer within the first audio-processing pipeline to store the first audio data, for further processing with the second program module, wherein the multiple layers comprise the first layer and the second layer; and utilizing at least one subsequent program module within the first audio-processing pipeline to process the first audio data, for offloading among different portions of the at least one processor, wherein the at least one subsequent program module comprises the second program module. According to some embodiments, the method may further comprise: utilizing at least one other audio-processing pipeline among the multiple audio-processing pipelines to process at least one other audio data having at least one other playback length greater than the first predetermined playback length.

According to some embodiments, the present invention also provides the electronic device that operates according to the method mentioned above, where the electronic device may be arranged to utilize at least one other audio-processing pipeline among the multiple audio-processing pipelines to process at least one other audio data having at least one other playback length greater than the first predetermined playback length.

It is an advantage of the present invention that the present invention method and the associated apparatus such as the electronic device operating according to the method can achieve power consumption optimization specifically for short audio sounds with the aid of the novel offload architecture. Additionally, the present invention method and the associated apparatus can solve the problem of the related art without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device with multi-pipeline architecture regarding audio processing according to an embodiment of the present invention.

FIG. 2 is a diagram illustrating a short audio offload control scheme of a method for performing audio offload control in multi-pipeline architecture according to an embodiment of the present invention, where some cases may be illustrated as being taken over by a certain audio-processing pipeline among multiple audio-processing pipelines shown in of FIG. 1 for better comprehension.

FIG. 3 is a diagram illustrating a first audio-processing control scheme of the method according to an embodiment of the present invention.

FIG. 4 is a diagram illustrating a second audio-processing control scheme of the method according to an embodiment of the present invention.

FIG. 5 is a diagram illustrating a third audio-processing control scheme of the method according to an embodiment of the present invention.

FIG. 6 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

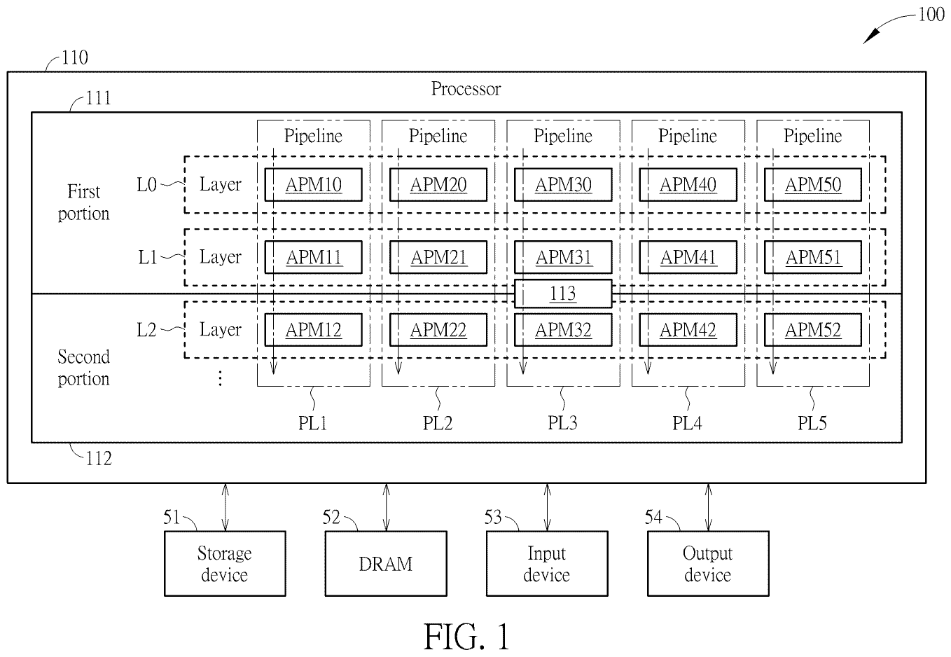

FIG. 1 is a diagram illustrating an electronic device 100 with multi-pipeline architecture regarding audio processing according to an embodiment of the present invention. Examples of the electronic device 100 may include, but are not limited to: a personal computer (PC) such as a desktop computer and a laptop computer, an all in one (AIO) computer, a tablet computer and a multifunctional mobile phone as well as a wearable device. The electronic device 100 may comprise at least one processor (e.g., one or more processors) which may be collectively referred to as the processor 110, and further comprise at least one storage device such as a storage device 51, at least one random access memory (RAM) which may be implemented as a dynamic random access memory (DRAM) 52, as well as at least one input device and at least one output device which may be collectively referred to as the input device 53 and the output device 54, respectively, where the processor 110 may comprise a first portion 111 and a second portion 112 of the aforementioned at least one processor. The aforementioned at least one processor such as the processor 110 may comprise multiple audio-processing pipelines {PL1, . . . PL(X)}, for performing various types of audio processing, respectively, and any audio-processing pipeline PL(x) among the multiple audio-processing pipelines {PL1, . . . PL(X)} may comprise multiple audio-processing modules {APM(x, y)} (e.g., Y(x) audio-processing modules {APM(x, y=0), . . . APM(x, y=(Y (x)−1))) running on the aforementioned at least one processor within the electronic device 100, such as the multiple audio-processing modules {APM(x, y)} respectively belonging to multiple layers of program modules running on the aforementioned at least one processor, where the pipeline count X of the multiple audio-processing pipelines {PL1, . . . PL(X)} may be an integer that is greater than one, the audio-processing module count Y(x) of the audio-processing modules {APM(x, y)} within the aforementioned any audio-processing pipeline PL(x) may be an integer that is greater than on, the index x may represent an integer falling within the interval [1, X], and the index y may represent an integer falling within the interval [0, (Y(x)−1)].

For better comprehension, the multiple audio-processing pipelines {PL1, . . . PL(X)} may be illustrated as the audio-processing pipelines {PL1, PL2, PL3, PL4, PL5} (labeled “Pipeline” for brevity) for the case of X=5, and the audio-processing modules {APM(x, y)} of the multiple audio-processing pipelines {PL1, . . . PL(X)} may be illustrated as the audio-processing modules {{APM10, APM11, APM12, . . . }, {APM20, APM21, APM22, . . . }, {APM30, APM31, APM32, . . . }, {APM40, APM41, APM42, . . . }, {APM50, APM51, APM52, . . . }} belonging to the layers {L0, L1, L2, . . . }, respectively, but the present invention is not limited thereto. According to some embodiments, the multi-pipeline architecture, the distribution of the audio-processing modules {APM(x, y)} and the layers {L0, L1, L2, . . . } with respect to the portions (e.g., the first portion 111 and the second portion 112) of the aforementioned at least one processor, the pipeline count X of the multiple audio-processing pipelines {PL1, . . . PL(X)}, the audio-processing module count Y(x) of the audio-processing modules {APM(x, y)} within the aforementioned any audio-processing pipeline PL(x), and/or the layer count of the multiple layers may vary.

In the above embodiment, the storage device 51 can be implemented by way of a hard disk drive (HDD), a solid state drive (SSD) and a non-volatile memory such as a Flash memory, the input device 53 can be implemented by way of at least one audio input device such as a microphone, an audio input stage, an audio input port, etc. and at least one image input device such as a camera as well as at least one user input device such as a touch panel, etc., and the output device 54 can be implemented by way of at least one audio output device such as a speaker, an audio output stage, an audio output port, etc. and at least one display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 100 and/or the components therein may vary.

The electronic device 100 may be arranged to perform audio processing with the aid of the multi-pipeline architecture, and more particularly, perform audio offload control in the multi-pipeline architecture to save power of the first portion 111 of the aforementioned at least one processor (e.g., the processor 110). For example, the electronic device 100 may utilize a first audio-processing pipeline PL(x1) among the multiple audio-processing pipelines {PL1, PL(X)}, such as the audio-processing pipeline PL3 shown in FIG. 1, to perform first audio processing, and the first audio processing may comprise:

(1) the electronic device 100 may utilize the first audio-processing pipeline PL(x1) (e.g., the audio-processing pipeline PL3) to receive first audio data of a first audio, where a first playback length of the first audio data is less than a first predetermined playback length (e.g., one minute);

(2) the electronic device 100 may utilize a bitstream buffer 113 inserted between a first program module (e.g., the audio-processing module APM(x1, y1)) corresponding to a first layer L(y1) and a second program module (e.g., the audio-processing module APM(x1, y2)) corresponding to a second layer L(y2) within the first audio-processing pipeline PL(x1) to store the first audio data, for further processing with the second program module, where the multiple layers may comprise the first layer L(y1) and the second layer L(y2); and

(3) the electronic device 100 may utilize at least one subsequent program module (e.g., the audio-processing module(s) {APM(x, y)|x=x1, y≥y2}) within the first audio-processing pipeline PL(x1) (e.g., the audio-processing pipeline PL3) to process the first audio data, for offloading among different portions (e.g., the first portion 111 and the second portion 112) of the aforementioned at least one processor, where the aforementioned at least one subsequent program module may comprise the second program module (e.g., the audio-processing module APM(x1, y2)); where the bitstream buffer 113 may be illustrated as being inserted between the audio-processing modules APM31 and APM32 within the audio-processing pipeline PL3 for the case that x1=3 and (y1, y2)=(1, 2), but the present invention is not limited thereto. For example, the location of the bitstream buffer 113 with respect to the audio-processing modules {APM(x, y)} of the multiple audio-processing pipelines {PL1, . . . PL(X)} and/or the values of x1 and (y1, y2) may vary. In addition, the electronic device 100 may utilize at least one other audio-processing pipeline {PL(x)}|x≠x1} among the multiple audio-processing pipelines {PL1, . . . PL(X)}, such as the audio-processing pipeline PL1 shown in FIG. 1, to process at least one other audio data having at least one other playback length greater than the first predetermined playback length (e.g., one minute).

The bitstream buffer 113 may represent a shared bitstream buffer inserted between the first program module (e.g., the audio-processing module APM(x1, y1)) running on the first portion 111 of the aforementioned at least one processor and the second program module (e.g., the audio-processing module APM(x1, y2)) running on the second portion 112 of the aforementioned at least one processor, and may also be referred to as the shared bitstream buffer 113. For example, the bitstream buffer 113 may be implemented with a shared memory dedicated to the data exchange between the first program module (e.g., the audio-processing module APM(x1, y1)) and the second program module (e.g., the audio-processing module APM(x1, y2)), but the present invention is not limited thereto. According to some embodiments, the electronic device 100 may be arranged to configure a portion of memory space of the DRAM 52 to be the bitstream buffer 113. In addition, the aforementioned at least one processor may comprise a first processor such as an application processor (AP), and comprise a second processor such as an audio digital signal processor (ADSP), where the first portion 111 of the aforementioned at least one processor may represent the first processor, and the second portion 112 of the aforementioned at least one processor may represent the second processor, but the present invention is not limited thereto. According to some embodiments, the aforementioned at least one processor may comprise a first processor core and a second processor core, where the first portion 111 of the aforementioned at least one processor may represent the first processor core, and the second portion 112 of the aforementioned at least one processor may represent the second processor core.

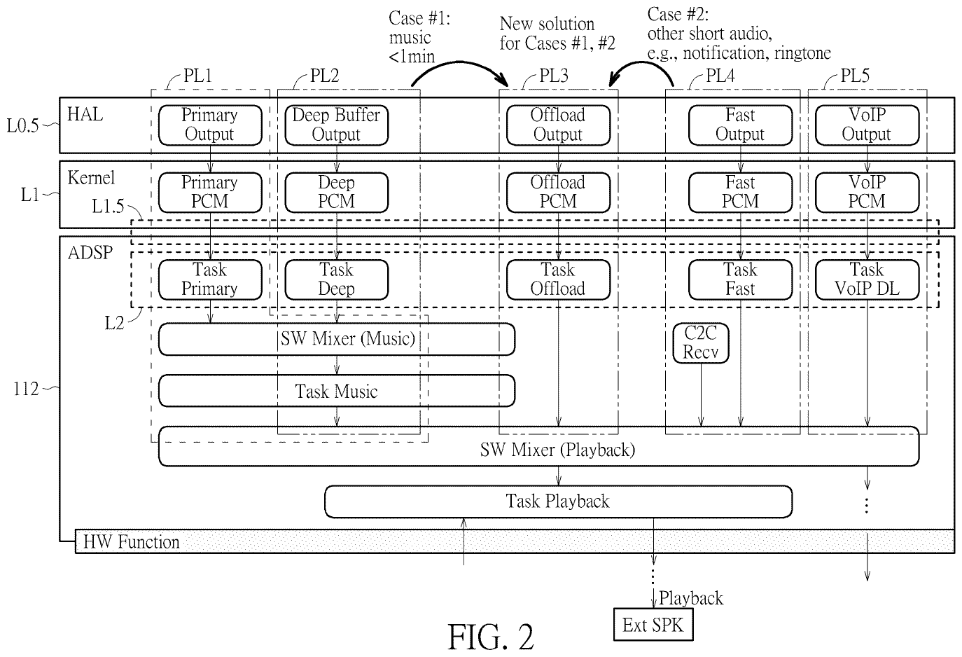

FIG. 2 is a diagram illustrating a short audio offload control scheme of a method for performing audio offload control in multi-pipeline architecture according to an embodiment of the present invention, where some cases such as Cases #1 and #2 may be illustrated as being taken over by the first audio-processing pipeline PL(x1) (e.g., the audio-processing pipeline PL3) among the multiple audio-processing pipelines {PL1, PL(X)} (e.g., the audio-processing pipelines {PL1, PL2, . . . , PL5}) for better comprehension. The first predetermined playback length may be equal to one minute. For example, in Case #1, the first audio may represent an audio clip of music with the playback length thereof being less than one minute; and in Case #2, the first audio may represent any audio among a notification sound, an alarm and a ringtone. In the architecture shown in FIG. 2, the audio-processing modules APM10, APM11 and APM12 within the audio-processing pipeline PL1 may represent the Primary Output module, the Primary Pulse-Code Modulation (PCM) module and the Task Primary module, respectively; the audio-processing modules APM20, APM21 and APM22 within the audio-processing pipeline PL2 may represent the Deep Buffer Output module, the Deep PCM module and the Task Deep module, respectively; the audio-processing modules APM30, APM31 and APM32 within the audio-processing pipeline PL3 may represent the Offload Output module, the Offload PCM module and the Task Offload module, respectively; the audio-processing modules APM40, APM41 and APM42 within the audio-processing pipeline PL4 may represent the Fast Output (or Fast Buffer Output) module, the Fast PCM module and the Task Fast module, respectively; and the audio-processing modules APM50, APM51 and APM52 within the audio-processing pipeline PL5 may represent the Voice over Internet Protocol (VoIP) Output module, the VoIP PCM module and the Task VoIP module, respectively. There may be some other modules such as software (SW) mixers respectively acting as a mixer regarding music and a mixer regarding playback (respectively labeled “SW Mixer (Music)” and “SW Mixer (Playback)” for brevity), their subsequent stages such as a Task Music module and a Task Playback module, a C2C Receive (Recv) module, etc., as well as a hardware (HW) Function module, which may be coupled to an external speaker (labeled “Ext SPK” for brevity). As shown in FIG. 2, there may be more layers such as the layers L1.5, L0.5, etc., where the layer L0.5 may represent a Hardware Abstract Layer (HAL), and the layer L1.5 may represent a ALSA Data Change layer, but the present invention is not limited thereto.

Regarding the new solution for Cases #1 and #2, in order to save power, the shared bitstream buffer 113 may be designed to be large enough, for example, having a size such as 32 kilobytes (KB), and a wake-lock control mechanism (not shown in FIG. 2) among multiple program modules running on the second portion 112 (e.g., the ADSP) of the aforementioned at least one processor (e.g., the processor 110) may be arranged to control a wake-lock flag, for controlling wake-lock of the first portion 111 (e.g., the AP) of the aforementioned at least one processor. When the first portion 111 of the aforementioned at least one processor writes the first audio data into the shared bitstream buffer 113, the wake-lock control mechanism may hold the wake-lock flag in a wake-lock state to keep a first system (e.g., an AP system) of the first portion 111 (e.g., the AP) of the aforementioned at least one processor awake. After the first audio data is written, the wake-lock control mechanism may release the wake-lock flag from the wake-lock state to allow the first system (e.g., the AP system) to enter a suspend mode for saving power. For example, the second portion 112 of the aforementioned at least one processor may handle data decoding of the first audio data to generate first decoded data corresponding to the first audio data. When the second portion 112 of the aforementioned at least one processor finishes writing the first decoded data into the shared bitstream buffer 113, the wake-lock control mechanism may ensure that the wake-lock flag is held in the wake-lock state to wake up the first system (e.g., the AP system), for completing playback of the first audio.

In addition, an offload state-change judgment mechanism (not shown in FIG. 2) among the multiple program modules running on the second portion 112 (e.g., the ADSP) of the aforementioned at least one processor may be arranged to perform offload state-change judgment to keep being aware of any offload state-change. The first layer L(y1) may represent a kernel of an operating system (OS) (e.g., Linux) running on the first portion 111 (e.g., the AP) of the aforementioned at least one processor, and the kernel may be arranged to enter a drain-wait state after receiving a drain command, where processing the first audio data in the second portion 112 of the aforementioned at least one processor is completed before the kernel enters the drain-wait state. The offload state-change judgment mechanism may control timing of sending a drain ready (or drain-ready) command, to make the drain ready command be sent to the kernel after the kernel enters the drain-wait state, for preventing the kernel from missing the drain ready command. For example, the offload state-change judgment mechanism may control the timing of sending the drain ready command, to make the second portion 112 of the aforementioned at least one processor operate normally after sending the drain ready command. During controlling the timing of sending the drain ready command, the wake-lock control mechanism may maintain the wake-lock flag to prevent the first system (e.g., the AP system) from entering a sleep mode and failing to wake up, for ensuring smooth playback of the first audio. Since the short audio data can be quickly processed in the ADSP, if the data is processed before entering the drain-wait state after receiving the drain command, sending the drain ready command will cause problems in the current Linux Kernel design. Implementing the offload state-change judgment mechanism can ensure that the second portion 112 (e.g., the ADSP) of the aforementioned at least one processor operate normally after sending the drain ready command. At the same time, the wake-lock should be maintained to prevent the AP system from entering the sleep mode and failing to wake up, thus ensuring the smooth playback of audio.

Additionally, an audio-track repetitive patterns playing mechanism (not shown in FIG. 2) among multiple program modules running on the first portion 111 (e.g., the AP) of the aforementioned at least one processor may be arranged to perform repetitive patterns playing control, in order to repeatedly play at least one audio for at least one period of time, where the aforementioned at least one audio may comprise the first audio. When playing any audio data of the aforementioned at least one audio with repetitive patterns, the audio-track repetitive patterns playing mechanism may keep the aforementioned any audio data in the shared bitstream buffer 113, having no need to repeatedly write a same data which is the aforementioned any audio data into the shared bitstream buffer 113. For example, the second portion 112 (e.g., the ADSP) of the aforementioned at least one processor may handle data decoding of the aforementioned any audio data to generate decoded data corresponding to this audio data, for being played back during the aforementioned at least one period of time, and the aforementioned at least one audio may comprise an alarm and a ringtone.

TABLE 1

| | Short audio | |
|---|---|---|
| | non-offloadable | Short audio offload |
| Scenario | control scheme | control scheme |
| Playing music of | Offloadable; but | Offloadable; |
| length >1 minute | AP keeps awake | AP can enter Suspend |
| Playing music of | Non-offloadable; | Offloadable; |
| length <1 minute | use Deep Buffer Output | AP can enter Suspend |
| Playing short | Non-offloadable; | Offloadable; |
| audio (non-music) | use Fast Buffer Output | Depending on the |
| | (with Limitation: | length of the audio |
| | taking about 1-3 | (<1 second), the AP may |
| | seconds to close) | not have enough time |
| | | to enter Suspend |
| Playing short | Non-offloadable; | Offloadable; |
| audio with | use Fast Buffer Output | AP can enter Suspend |
| repetitive | (with AOSP Limitation: | AudioTrack does not |
| patterns | taking about 1-3 | need to write |
| | seconds to close) | repetitive patterns, |
| | AudioTrack needs to | while keeping the data |
| | write repetitive | in bitstream buffer |
| | patterns | |

Table 1 illustrates respective features of the short audio offload control scheme and a short audio non-offloadable control scheme, where the short audio offload control scheme is much better than the short audio non-offloadable control scheme for any scenario among the scenarios of playing music of a length greater than one minute, playing music of a length less than one minute, playing a short non-music audio and playing a short audio with repetitive patterns. For better comprehension, assume that a first electronic device which is not equipped with the associated architecture (e.g., the shared bitstream buffer 113) corresponding to the new solution may operate according to the short audio non-offloadable control scheme, but the present invention is not limited thereto. Regarding Case #1, the first electronic device may use the “Deep Buffer” Output module therein to play the music stream when its total length is less than one minute. Regarding Case #2, the first electronic device may use the Fast Output module therein to play the notifications and the ringtones, with a limitation that the sound cannot be immediately closed, for example, taking about 1-3 seconds to close the sound. In addition, the first electronic device may always hold the wake-lock in Offload Output module therein. Based on the short audio offload control scheme, the electronic device 110 can enter the suspend mode (labeled “Suspend” in Table 1 for brevity), for example, as a result of controlling the task (e.g., the decoding task) to be Offloadable from the first portion 111 of the aforementioned at least one processor to the second portion 112 of the aforementioned at least one processor. For example, in most scenarios among all scenarios shown in Table 1, the electronic device 110 can enter the suspend mode to save power. In the scenario of playing a short non-music audio, the AP may immediately perform a next operation to enhance the overall performance, having no need to enter the suspend mode.

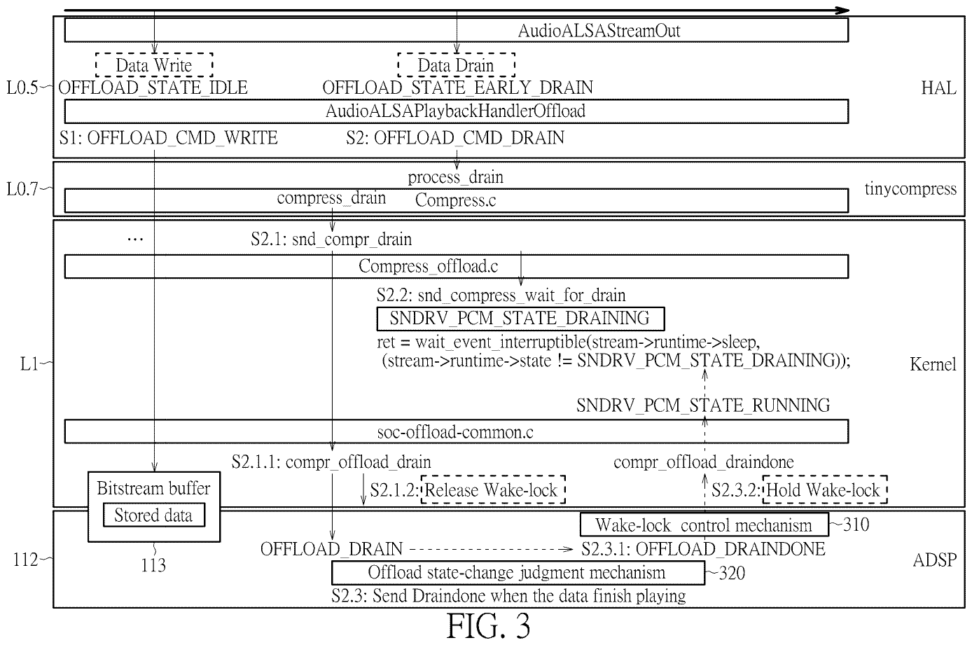

FIG. 3 is a diagram illustrating a first audio-processing control scheme of the method according to an embodiment of the present invention, where the process of the wake-lock control mechanism and the offload state-change judgment mechanism when returning the drain ready after the data processed well by the decoder in the ADSP may be illustrated as shown in FIG. 3, but the present invention is not limited thereto. The program modules in the layer L0.5 such as the HAL may comprise an AudioALSAStreamOut (or Audio ALSA Stream Out) module and an AudioALSAPlaybackHandlerOffload (or Audio ALSA Playback Handler Offload) module among, the program modules in the layer L0.7 such as the tinycompress (or tiny-compress) may comprise a Compress.c module, the program modules in the layer L1 such as the Kernel may comprise a Compress offload.c module and a soc-offload-common.c module, and the program modules in the layer L2 may comprise the wake-lock control mechanism 310 and the offload state-change judgment mechanism 320. Regarding Data Write with the idle offload state OFFLOAD_STATE_IDLE, the electronic device 100 may execute the offload write command OFFLOAD_CMD_WRITE in Step S1 to store all data into the bitstream buffer 113. Regarding Data Drain with the early-drain offload state OFFLOAD_STATE_EARLY_DRAIN, the electronic device 100 may execute the offload drain command OFFLOAD_CMD_DRAIN in Step S2, in order to start performing the associated tasks, where the names of the associated tasks may indicate their operations, respectively. For example, the electronic device 100 may execute the send compress drain task snd_compr_drain in Step S2.1, and more particularly, execute the compress offload drain task compr_offload_drain in Step S2.1.1 and release the wake-lock in Step S2.1.2, and further execute the send compress wait for drain task snd_compress_wait_for_drain in Step S2.2 to wait for the drain-done such as the completion of the Data Drain, in particular, by using the SNDRV PCM state draining task SNDRV_PCM_STATE_DRAINING to obtain the return value “ret”, such as ret=wait event interruptible (stream->runtime->sleep, (stream->runtime->state !=SNDRV_PCM_STATE_DRAINING)), in which SNDRV_PCM_STATE_DRAINING may depend upon (e.g., be equal to) the associated return information such as compr_offload_draindone and SNDRV_PCM_STATE_RUNNING on the return paths indicated by the arrows depicted with dashed lines. The electronic device 100 may use the offload state-change judgment mechanism 320 to perform the offload state-change judgment, and return in Step S2.3 to send the Draindone (e.g., the drain-done indicator) when the data playing is finished, and more particularly, send the offload drain-done indicator OFFLOAD_DRAINDONE in Step S2.3.1. The electronic device 100 may use the wake-lock control mechanism 310 to perform the wake-lock control, and hold the wake-lock in Step S2.3.2.

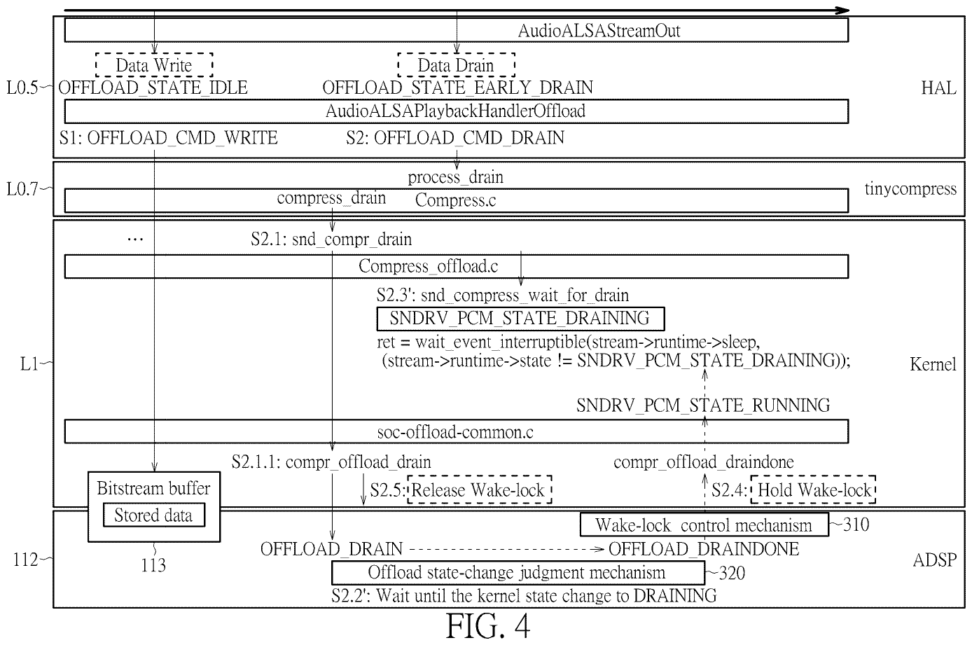

FIG. 4 is a diagram illustrating a second audio-processing control scheme of the method according to an embodiment of the present invention, where the process of the wake-lock control mechanism and the offload state-change judgment mechanism when the data is too short to wait the drain command may be illustrated as shown in FIG. 4, and during the process, the wake-lock control mechanism may always hold the wake lock and the offload state-change judgment mechanism may return after the kernel state change, but the present invention is not limited thereto. The program modules in the layers L0.5, L0.7, L1 and L2 and Steps S1 and S2 as shown in FIG. 4 may be the same as that shown in FIG. 3, respectively, but some operations may be performed in a different order. For example, the electronic device 100 may execute the send compress drain task snd_compr_drain in Step S2.1, and more particularly, execute the compress offload drain task compr_offload_drain in Step S2.1.1. The electronic device 100 may use the offload state-change judgment mechanism 320 to perform the offload state-change judgment, and wait until the kernel state changes to DRAINING in Step S2.2′, and further execute the send compress wait for drain task snd_compress_wait_for_drain in Step S2.3′. The electronic device 100 may use the wake-lock control mechanism 310 to perform the wake-lock control, and hold the wake-lock in Step S2.4 and release the wake-lock in Step S2.5. For brevity, similar descriptions for this embodiment are not repeated in detail here.

Under control of the wake-lock control mechanism 310 and the offload state-change judgment mechanism 320, the electronic device 100 can operate correctly on the return paths indicated by the arrows depicted with dashed lines, and more particularly, return the drain ready after the data processed well by the decoder in the ADSP, and therefore can prevent the related art problems, such as the problem of getting stuck at the execution of the send compress wait for drain task snd_compress_wait_for_drain due to the kernel failing to receive the drain ready command and keeping waiting for the drain ready command, and the problem of being not able to continue the playback of the audio.

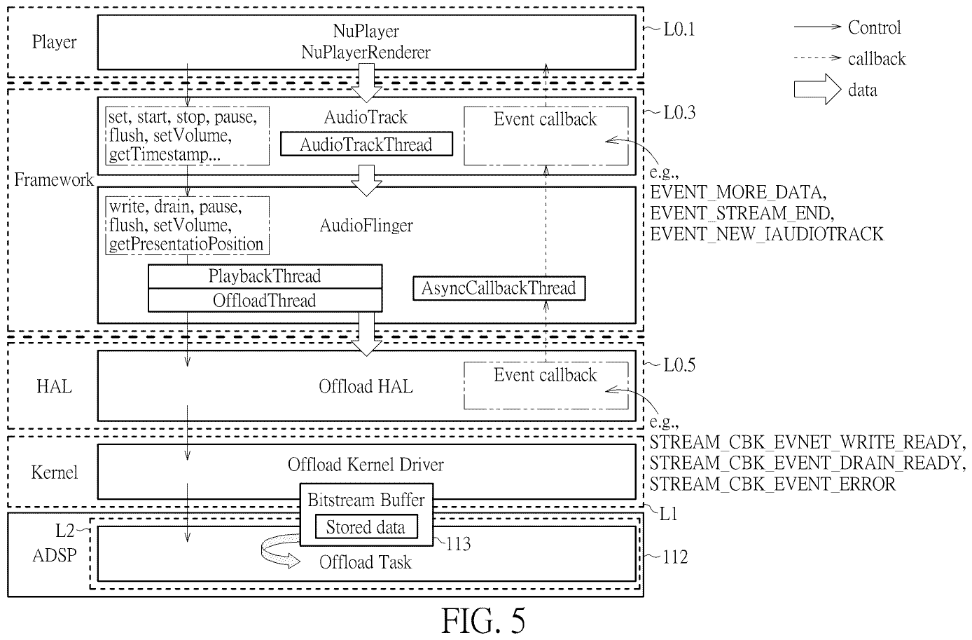

FIG. 5 is a diagram illustrating a third audio-processing control scheme of the method according to an embodiment of the present invention. The program modules in the layer L0.1 such as the Player may comprise a Nu-Player (or “NuPlayer”) module and a Nu-Player-Renderer (or “NuPlayerRenderer”) module, the program modules in the layer L0.3 such as the Framework may comprise an Audio-Track (or “AudioTrack”) module running an Audio-Track Thread (or “AudioTracThread”) and an Audio-Flinger (or “AudioFlinger”) module running a PlaybackThread (or “PlaybackThread”), an Offload Thread (or “OffloadThread”) and an Asynchronous (Async)-Callback Thread (or “AsyncCallbackThread”), the program modules in the layer L0.5 such as the HAL may comprise an Offload HAL module, and the program modules in the layer L1 such as the Kernel may comprise an Offload Kernel Driver. As shown in the left half part of FIG. 5, the AudioTrack module may execute various control such as set, start, stop, pause, flush, set Volume (or “setVolume”), get Time-stamp (or “getTimestamp”), etc., and the AudioFlinger module may execute the associated control such as write, drain, pause, flush, set Volume (or “setVolume”), get Presentatio-Position (or “getPresentatioPosition”), etc. As shown in the right half part of FIG. 5, the Offload HAL module may return the event callback such as STREAM_CBK_EVNET_WRITE_READY, STREAM_CBK_EVENT_DRAIN_READY, STREAM_CBK_EVENT_ERROR, etc., and the AudioTrack module may return the event callback such as EVENT_MORE_DATA, EVENT_STREAM_END, EVENT_NEW_IAUDIOTRACK, etc.

In addition, an Offload Task may run in the layer L2 to repeatedly play the aforementioned at least one audio for the aforementioned at least one period of time. When playing the aforementioned any audio data of the aforementioned at least one audio with repetitive patterns, the audio-track repetitive patterns playing mechanism such as the architecture shown in FIG. 5 may keep the aforementioned any audio data (e.g., the stored data) in the shared bitstream buffer 113 for repetitive playback (illustrated with the curved hollow arrow in the bottommost part of FIG. 5 for better comprehension), having no need to repeatedly write the same data which is the aforementioned any audio data into the shared bitstream buffer 113. For brevity, similar descriptions for this embodiment are not repeated in detail here.

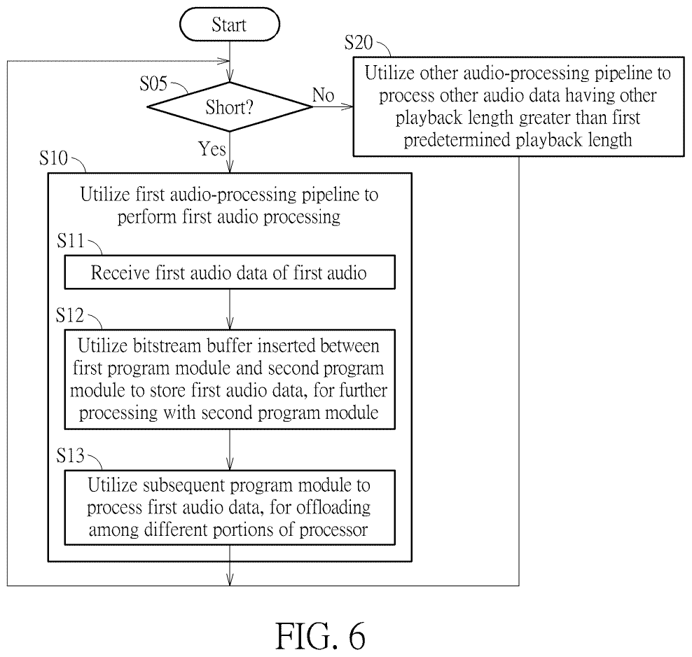

FIG. 6 illustrates a working flow of the method according to an embodiment of the present invention. The electronic device 100 may perform the audio offload control in the multi-pipeline architecture according to the working flow shown in FIG. 6.

In Step S05, the electronic device 100 may check whether a target audio to be played back is a short audio (labeled “Short” for brevity). If Yes, Step S10 is entered; if No, Step S20 is entered. For example, the electronic device 100 may determine whether the target audio is the short audio according to whether a length (e.g., a playback length) of the target audio is less than the first predetermined playback length (e.g., one minute), where the electronic device 100 may determine that the target audio is the short audio when the length of the target audio is less than the first predetermined playback length, and determine that the target audio is not any short audio when the length of the target audio is greater than the first predetermined playback length, but the present invention is not limited thereto. In some examples, if the length of the target audio is less than the first predetermined playback length, the electronic device 100 may determine that the target audio is the short audio; otherwise, the electronic device 100 may determine that the target audio is not any short audio.

As a result of executing Step S05, for any case among Cases #1 and #2, the electronic device 100 may process the target audio such as any short audio among the audio clip of music with the playback length thereof being less than one minute, the notification sound, the alarm and the ringtone in Step S10; and for any other case among some other cases, the electronic device 100 may process the target audio such as any non-short audio (e.g., the music with the playback length thereof being greater than one minute) in Step S20.

In Step S10, the electronic device 100 may utilize the first audio-processing pipeline PL(x1) (e.g., the audio-processing pipeline PL3) among the multiple audio-processing pipelines {PL1, . . . PL(X)} to perform the first audio processing on the first audio, such as the target audio for the aforementioned any case among Cases #1 and #2. Step S10 may comprise multiple sub-steps such as Steps S11-S13.

In Step S11, the electronic device 100 may utilize the first audio-processing pipeline PL(x1) (e.g., the audio-processing pipeline PL3) to receive the first audio data of the first audio, such as target audio data of the target audio for the aforementioned any case among Cases #1 and #2, where the first playback length of the first audio data, such as the length of the target audio data, is less than the first predetermined playback length (e.g., one minute).

In Step S12, the electronic device 100 may utilize the bitstream buffer 113 inserted between the first program module (e.g., the audio-processing module APM(x1, y1)) corresponding to the first layer L(y1) and the second program module (e.g., the audio-processing module APM(x1, y2)) corresponding to the second layer L(y2) within the first audio-processing pipeline PL(x1) to store the first audio data, such as the target audio data for the aforementioned any case among Cases #1 and #2, for further processing with the second program module.

In Step S13, the electronic device 100 may utilize the aforementioned at least one subsequent program module (e.g., the audio-processing module(s) {APM(x, y)|x=x1, y≥y2}) within the first audio-processing pipeline PL(x1) (e.g., the audio-processing pipeline PL3) to process the first audio data, such as the target audio data for the aforementioned any case among Cases #1 and #2, for offloading among the aforementioned different portions (e.g., the first portion 111 and the second portion 112) of the aforementioned at least one processor (e.g., the processor 110), where the aforementioned at least one subsequent program module may comprise the second program module (e.g., the audio-processing module APM(x1, y2)).

In Step S20, the electronic device 100 may utilize any other audio-processing pipeline PL(x) (e.g., the audio-processing pipeline PL1) of the aforementioned at least one other audio-processing pipeline {PL(x)}|x≠x1} among the multiple audio-processing pipelines {PL1, . . . PL(X)} to process any other audio data among the aforementioned at least one other audio data having the aforementioned at least one other playback length greater than the first predetermined playback length, such as the target audio data for the aforementioned any other case among the other cases. For brevity, similar descriptions for this embodiment are not repeated in detail here.

For better comprehension, the method may be illustrated with the working flow shown in FIG. 6, but the present invention is not limited thereto. According to some embodiments, one or more steps may be added, deleted, or changed in the working flow shown in FIG. 6. For example, the electronic device may utilize the first audio-processing pipeline PL(x1) (e.g., the audio-processing pipeline PL3) among the multiple audio-processing pipelines {PL1, . . . PL(X)} to perform second audio processing. More particularly, the second audio processing may comprise: utilizing the first audio-processing pipeline PL(x1) to receive second audio data of a second audio, where a second playback length of the second audio data is less than a second predetermined playback length; utilizing the bitstream buffer 113 inserted between the first programmodule (e.g., the audio-processing program module APM31) corresponding to the first layer L1 and the second program module (e.g., the audio-processing program module APM32) corresponding to the second layer L2 within the first audio-processing pipeline PL(x1) (e.g., the audio-processing pipeline PL3) to store the second audio data, for further processing with the second program module; and utilizing the aforementioned at least one subsequent program module within the first audio-processing pipeline PL(x1) (e.g., the audio-processing pipeline PL3) to process the second audio data, for offloading among the aforementioned different portions of the aforementioned at least one processor (e.g., the processor 110). In addition, at least one predetermined playback length (e.g., any predetermined playback length or all predetermined playback lengths) among the first predetermined playback length and the second predetermined playback length may be equal to one minute. For example, the first audio may represent an audio clip of music, and the second audio may represent any audio among a notification sound, an alarm and a ringtone, where the aforementioned at least one predetermined playback length may comprise the first predetermined playback length. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing audio offload control in multi-pipeline architecture, the method being applied to an electronic device, the method comprising:
utilizing a first audio-processing pipeline among multiple audio-processing pipelines to perform first audio processing, wherein each audio-processing pipeline among the multiple audio-processing pipelines comprises multiple audio-processing modules running on at least one processor within the electronic device, the multiple audio-processing modules respectively belonging to multiple layers of program modules running on the at least one processor, and the first audio processing comprises:
utilizing the first audio-processing pipeline to receive first audio data of a first audio, wherein a first playback length of the first audio data is less than a first predetermined playback length;
utilizing a bitstream buffer inserted between a first program module corresponding to a first layer and a second program module corresponding to a second layer within the first audio-processing pipeline to store the first audio data, for further processing with the second program module, wherein the multiple layers comprise the first layer and the second layer; and
utilizing at least one subsequent program module within the first audio-processing pipeline to process the first audio data, for offloading among different portions of the at least one processor, wherein the at least one subsequent program module comprises the second program module.

2. The method of claim 1, wherein the first predetermined playback length is equal to one minute.

3. The method of claim 2, wherein the first audio represents an audio clip of music.

4. The method of claim 2, wherein the first audio represents any audio among a notification sound, an alarm and a ringtone.

5. The method of claim 1, further comprising:
utilizing the first audio-processing pipeline among the multiple audio-processing pipelines to perform second audio processing, wherein the second audio processing comprises:
utilizing the first audio-processing pipeline to receive second audio data of a second audio, wherein a second playback length of the second audio data is less than a second predetermined playback length;
utilizing the bitstream buffer inserted between the first program module corresponding to the first layer and the second program module corresponding to the second layer within the first audio-processing pipeline to store the second audio data, for further processing with the second program module; and
utilizing the at least one subsequent program module within the first audio-processing pipeline to process the second audio data, for offloading among said different portions of the at least one processor;
wherein at least one predetermined playback length among the first predetermined playback length and the second predetermined playback length is equal to one minute.

6. The method of claim 5, wherein the first audio represents an audio clip of music, and the second audio represents any audio among a notification sound, an alarm and a ringtone, wherein the at least one predetermined playback length comprises the first predetermined playback length.

7. The method of claim 1, wherein the bitstream buffer represents a shared bitstream buffer inserted between the first program module running on a first portion of the at least one processor and the second program module running on a second portion of the at least one processor.

8. The method of claim 7, wherein the at least one processor comprises a first processor and a second processor, wherein the first portion of the at least one processor represents the first processor, and the second portion of the at least one processor represents the second processor.

9. The method of claim 8, wherein the first processor is an application processor (AP), and the second processor is an audio digital signal processor (ADSP).

10. The method of claim 7, wherein the at least one processor comprises a first processor core and a second processor core, wherein the first portion of the at least one processor represents the first processor core, and the second portion of the at least one processor represents the second processor core.

11. The method of claim 7, wherein a wake-lock control mechanism among multiple program modules running on the second portion of the at least one processor is arranged to control a wake-lock flag, for controlling wake-lock of the first portion of the at least one processor; when the first portion of the at least one processor writes the first audio data into the shared bitstream buffer, the wake-lock control mechanism is arranged to hold the wake-lock flag in a wake-lock state to keep a first system of the first portion of the at least one processor awake; and after the first audio data is written, the wake-lock control mechanism is arranged to release the wake-lock flag from the wake-lock state to allow the first system to enter a suspend mode for saving power.

12. The method of claim 11, wherein the second portion of the at least one processor is arranged to handle data decoding of the first audio data to generate first decoded data corresponding to the first audio data; and when the second portion of the at least one processor finishes writing the first decoded data into the shared bitstream buffer, the wake-lock control mechanism is arranged to ensure that the wake-lock flag is held in the wake-lock state to wake up the first system, for completing playback of the first audio.

13. The method of claim 11, wherein an offload state-change judgment mechanism among the multiple program modules running on the second portion of the at least one processor is arranged to perform offload state-change judgment to keep being aware of any offload state-change; the first layer represent a kernel of an operating system (OS) running on the first portion of the at least one processor, and the kernel is arranged to enter a drain-wait state after receiving a drain command, wherein processing the first audio data in the second portion of the at least one processor is completed before the kernel enters the drain-wait state; and the offload state-change judgment mechanism is arranged to control timing of sending a drain ready command, to make the drain ready command be sent to the kernel after the kernel enters the drain-wait state, for preventing the kernel from missing the drain ready command.

14. The method of claim 13, wherein the offload state-change judgment mechanism is arranged to control the timing of sending the drain ready command, to make the second portion of the at least one processor operate normally after sending the drain ready command; and during controlling the timing of sending the drain ready command, the wake-lock control mechanism is arranged to maintain the wake-lock flag to prevent the first system from entering a sleep mode and failing to wake up, for ensuring smooth playback of the first audio.

15. The method of claim 7, wherein an audio-track repetitive patterns playing mechanism among multiple program modules running on the first portion of the at least one processor is arranged to perform repetitive patterns playing control, in order to repeatedly play at least one audio for at least one period of time, wherein the at least one audio comprises the first audio; and when playing any audio data of the at least one audio with repetitive patterns, the audio-track repetitive patterns playing mechanism is arranged to keep the any audio data in the shared bitstream buffer, having no need to repeatedly write a same data which is the any audio data into the shared bitstream buffer.

16. The method of claim 15, wherein the second portion of the at least one processor is arranged to handle data decoding of the any audio data to generate decoded data corresponding to the any audio data, for being played back during the at least one period of time.

17. The method of claim 15, wherein the at least one audio comprises an alarm and a ringtone.

18. The method of claim 1, wherein at least one other audio data with at least one other playback length greater than the first predetermined playback length is processed by at least one other audio-processing pipeline among the multiple audio-processing pipelines.

19. The electronic device that operates according to the method of claim 1, wherein the electronic device is arranged to utilize at least one other audio-processing pipeline among the multiple audio-processing pipelines to process at least one other audio data having at least one other playback length greater than the first predetermined playback length.
